(19) United States
(12) Patent Application Publication
(10) Pub. No.: US 2005/0253511 A1
(43) Pub. Date: Nov. 17, 2005

(54) Flexible EL lamp with reinforced leads

(75) Inventors: Charles I. Zovko, Chandler, AZ (US); David A. Hardinger, Apache Junction, AZ (US)

Correspondence Address: Paul F. Wille;Durel Division Rogers Corporation, 2225 W. Chandler Boulevard, Chandler, AZ, 85224, US

(73) Assignee: World Properties, Inc., Lincolnwood, IL (US)

(21) Appl. No.: 10/843,281

(22) Filed: May 11, 2004

(51) Int. Cl. H01J 1/62; H01J 63/04

(52) U.S. Cl. 313/511

(57) ABSTRACT

An EL panel includes a substrate 1-5 mils (0.25-1.26 mm) thick having contact areas reinforced by a strip screen printed or otherwise formed in or on the contact areas.

### BACKGROUND OF THE INVENTION

This invention relates to a thick film, inorganic, electroluminescent (EL) lamp and, in particular, to the construction of electrical leads for the lamp that can withstand soldering, even wave soldering.

As used herein, and as understood by those of skill in the art, “thick-film” refers to one type of EL lamp and “thin-film” refers to another type of EL lamp. The terms only broadly relate to thickness and actually identify distinct disciplines. In general, thin film EL lamps are made by vacuum deposition of the various layers, usually on a glass substrate or on a preceding layer. Thick-film EL lamps are generally made by depositing layers of inks on a substrate, e.g. by roll coating, spraying, or various printing techniques. The techniques for depositing ink are not exclusive, although the several lamp layers are typically deposited in the same manner, e.g. by screen printing. A thin, thick-film EL lamp is not a contradiction in terms and such a lamp is considerably thicker than a thin film EL lamp.

In the context of a thick film EL lamp, and as understood by those of skill in the art, “inorganic” refers to a crystalline, luminescent material, phosphor, that does not contain silicon or gallium as the host crystal. (A crystal may be doped accidentally, with impurities, or deliberately. “Host” refers to the crystal itself, not a dopant.) The term “inorganic” does not relate to the other materials from which an EL lamp is made. Thick film EL phosphor particles are typically zinc sulfide-based materials containing small amounts of other materials as color centers, as activators, or to modify defects in the crystal lattice to modify properties of the phosphor as desired.

As used herein, an EL “panel” is a single sheet including one or more luminous areas, wherein each luminous area is an EL “lamp.” An EL lamp is essentially a capacitor having a dielectric layer between two conductive electrodes, at least one of which is transparent. The dielectric layer can include a phosphor powder or there can be a separate layer of phosphor powder adjacent the dielectric layer. The phosphor powder radiates light in the presence of a strong electric field, using relatively little current.

A modern (post-1990) EL lamp typically includes transparent substrate of polyester or polycarbonate material having a thickness of about 7.0 mils (0.178 mm.). A transparent, front electrode of indium tin oxide or indium oxide is vacuum deposited onto the substrate to a thickness of 1000 A° or so. A phosphor layer is screen printed over the front electrode and a dielectric layer is screen printed over phosphor layer. A rear electrode is screen printed over the dielectric layer. It is also known in the art to deposit the layers by roll coating.

The inks used for screen printing include a binder, a solvent, and a filler, wherein the filler determines the nature of the ink. As long known in the art, having the solvent and binder for each layer be chemically the same or chemically similar provides chemical compatibility and good adhesion between adjacent layers; e.g., see U.S. Pat. No. 4,816,717 (Harper et al.). It is not easy to find chemically compatible phosphors, dyes, binders, fillers, solvents or carriers and to produce, after curing, the desired physical properties, such as flexibility, and the desired optical properties, such as color and brightness.

A panel constructed in accordance with the prior art is relatively stiff, even though it is typically only seven mils thick, making it difficult to mold into a three dimensional surface, for example. Layer thickness and stiffness are not directly related. The material from which the layer is made affects stiffness.

Relatively flexible EL panels are known in the art. Unlike panels made on substrates that are seven mils thick (0.178 mm.), or so, EL panels made on thin substrates from flexible materials, e.g. urethane one to five mils thick, do not keep their shape but bend or curl. EL lamps made with polyurethane layers are known; see U.S. Pat. No. 4,297,681 (Dircksen) and U.S. Pat. No. 5,856,030 (Burrows). The thinness and flexibility of such a panel makes it difficult to automate the assembly of panels into products and, in particular, to solder the leads on a panel without melting the panel.

In the automatic assembly of EL lamps into products, customers often want to subject EL lamps to what is known as wave soldering. In wave soldering, one side of a printed circuit board, or other device containing leads to be electrically connected, is brought into contact with a large puddle of solder, thereby simultaneously soldering all connections on the board. Wave soldering enables one to connect a large number of devices in a single step, obtaining high volume and low cost. It also can partially melt the lead area of thin, thick film EL panels. Similar to wave soldering, solder bumps on a circuit board are briefly heated to provide simultaneous connections to a plurality of devices. Alternatives, such as spot soldering or laser soldering, are more expensive to perform and require more costly equipment. Mechanical connections, such as crimping the leads, are also more expensive and subject to defects because of the frail nature of the leads.

Transient melting is not unknown in the art. U.S. Pat. No. 6,521,916 (Roberts et al.) discloses that “The most common compromise used to get around the transient temperature rise problem associated with soldering is to simply increase the thermal resistance of the electrical leads used in the device construction. By increasing the thermal resistance of these solderable leads, the heat transient experienced within the device body during soldering is minimized. Such an increase in thermal resistance can typically be accomplished in the following manner without appreciably affecting the electrical performance of the leads: 1) using a lead material with lower thermal conductivity (such as steel); 2) increasing the stand-off length of the leads (distance between solder contact and the device body); or 3) decreasing the cross-sectional area of the leads.”

While the quoted principles may be of use for LEDs and other light emitting semiconductors described in the patent, the principles do not apply to EL panels. One reason is that the leads already have a substantial thermal resistance because they are made from conductive ink, not metal, and, particularly, not copper.

In view of the foregoing, it is therefore an object of the invention to provide a flexible EL lamp compatible with known soldering techniques, including wave soldering.

Another object of the invention is to provide a flexible EL lamp compatible with mechanical connectors.

A further object of the invention is to provide a lead construction for an EL lamp that is chemically compatible with the rest of the lamp.

Another object of the invention is to provide a lead construction for an EL lamp that enables bonding the lamp to a printed circuit board.

### SUMMARY OF THE INVENTION

The foregoing objects are achieved in this invention in which an EL panel includes a substrate 1-5 mils (0.25-1.26 mm) thick having contact areas reinforced by a strip printed, coated, deposited or otherwise formed in or on the contact areas.

### BRIEF DESCRIPTION OF THE DRAWINGS

A more complete understanding of the invention can be obtained by considering the following detailed description in conjunction with the accompanying drawings, in which:

FIG. 1 is a cross-section of an EL lamp constructed in accordance with a preferred embodiment of the invention;

FIG. 2 is a cross-section of an EL lamp with a connector constructed in accordance with a preferred embodiment of the invention;

FIG. 3 is a plan view of a crimp connector;

FIG. 4 is an end view of a cross-section of an EL lamp with a connector constructed in accordance with a preferred embodiment of the invention;

FIG. 5 is a cross-section of an EL lamp with a connector constructed in accordance with another aspect of the invention; and

FIG. 6 is a cross-section of an EL lamp with a connected to a printed circuit board in accordance with another aspect of the invention.

### DETAILED DESCRIPTION OF THE INVENTION

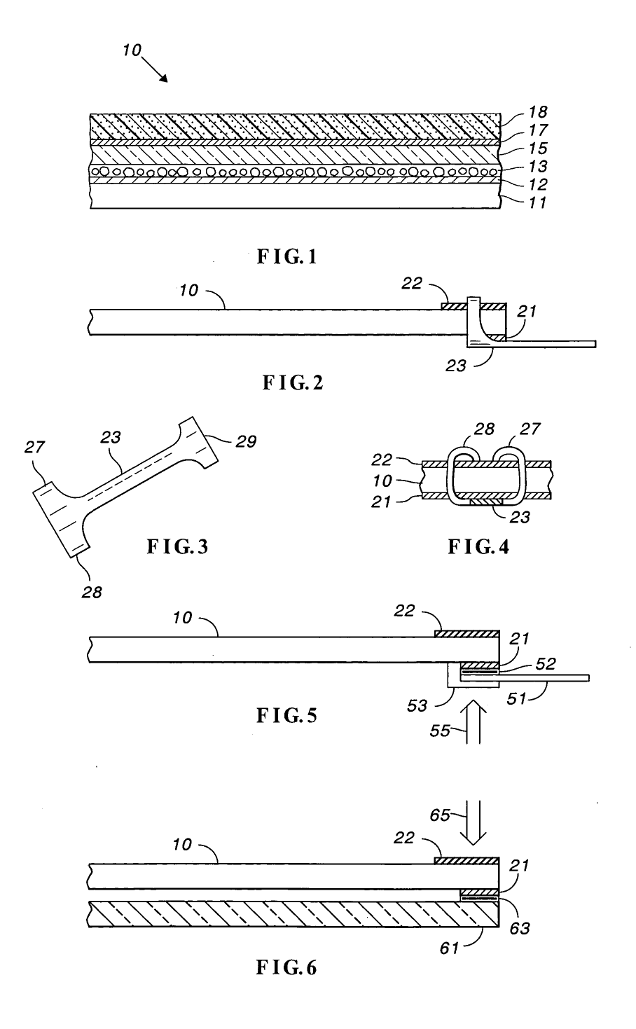

FIG. 1 is a cross-section of a flexible EL lamp. The various layers are not shown in proportion. In lamp 10, release film 11 supports resin envelope layer 12. Transparent front electrode 13 overlies layer 12 and is a layer of PEDOT or indium tin oxide powder in a vinyl gel. (PEDOT (polyethylene-dioxithiophene) is a stable and transparent conductive polymer that can be screen printed with other layers to make an EL panel.) Phosphor layer 15 overlies the front electrode and dielectric layer 16 overlies the phosphor layer. Layers 15 and 16 are combined in some applications. Overlying dielectric layer 16 is opaque rear electrode 17. Envelope layer 18 seals lamp 10 about the periphery thereof (not shown). None of the layers is drawn to scale. Layer 18, for example, is about 1 mil. (0.025 mm) thick, as are the phosphor layer and the dielectric layer.

FIG. 2 a cross-section of an EL lamp with a connector constructed in accordance with a preferred embodiment of the invention. Lamp 10 includes bus bar 21 for distributing power across the area of the lamp. Bus bar 21 is preferably a screen printed conductive ink, including carbon particles or silver particles. In accordance with the invention, lamp 10 further includes flexible strip 22, preferably made by screen printing a UV curable insulating layer, such as Acheson 452SS, along the crimp area of the lamp to a thickness of <1 mil (0.025 mm), e.g. 0.5 mil (0.013 mm). After strip 22 cures, connector 23 is crimped to lamp 10. The lamp does not deform because it is reinforced by strip 22, even though the lamp is only 1-5 mils (0.025-0.127 mm) thick. Lamps without strip 22 survived dipping into molten solder (270° C.) for three seconds. However, when exposed to molten solder for five seconds, the crimp connectors fell off the lamps. Lamps with strip 22 were dipped into molten solder at 290° C. for three, five, and ten seconds. All survived without any visible damage.

Crimp connector 23 is shown in plan view in FIG. 3 and in cross-section in FIG. 4. Connector 23 is typically a thin sheet of tinned copper. Ends 27 and 28 (FIG. 3) are curved to a position perpendicular to the plane of the connector and forced through an EL lamp, easily penetrating the conductive layers of the lamp. The ends are then curved back on to strip 22, as illustrated in FIG. 4, securing the connector somewhat like a staple. The mechanical touching of connector 23 to bus bar 21 is relied on for electrical connection. Because of the extremely low currents and high voltages used in driving an EL lamp, the mechanical connection is more than adequate. Other types of crimp connectors are known in the art and can be used to implement the invention. End 29 is crimped about a wire or rolled and inserted into a printed circuit board.

It has been found that the improved heat resistance and mechanical resistance of a lamp constructed in accordance with the invention enables other kinds of connection. In FIG. 5, conductive lead 51 is thermally bonded to EL lamp 10. Lamp 10 includes bus bar 21 and insulating strip 22. Overlying bus bar 21 is z-axis adhesive or tape 52, such as available from 3M Corporation. Lead 51 is held in a suitable jig (not shown) and heat and pressure, represented by arrow 55, are applied to bond lead 51 to lamp 10. Insulating tape 53 is applied over the bus bar and lead to prevent shorting. Tape 53 can be applied prior to bonding.

Heat and pressure are applied by a suitable tool or platen. A pressure of 45 psi (=300 kPa.) is sufficient but not critical. Temperature and time are inversely related. To increase productivity, time must be shortened, which requires higher temperatures. The flexible strip prevents damage to the lead areas of the lamp. For example, 90° C. for 25 seconds has been found suitable and 110° C. for 10 seconds has been found suitable. These are not limits but examples.

FIG. 6 illustrates another aspect of the invention wherein EL lamp 10 is bonded to printed circuit board 61. Z-axis adhesive or tape 63 overlies bus bar 21 and couples lamp 10 to printed circuit board 61. Heat and pressure, represented by arrow 65, are applied to bond lamp 10 to a contact area (not shown) on printed circuit board 61. Because of strip 22, lamp 10 is sufficiently stable in the area of the bond to provide a reliable electrical and mechanical connection.

The invention thus provides a flexible EL lamp compatible with known soldering techniques, including wave soldering, and with mechanical connectors. The lead construction is chemically compatible with the rest of the lamp and uses materials that are chemically the same as or similar to the rest of the lamp. Crimp leads or bonded leads can be used. Any sort of crimp connector can be used, e.g. an eyelet for coupling to a flexible connector.

Having thus described the invention, it will be apparent to those of skill in the art that various modifications can be made within the scope of the invention. For example, bus bars can be on either side or both sides of the EL lamp. Any ink is suitable as long as the leads are not electrically shorted. That is, a particular lamp application may lend itself to incorporating the reinforcing strip between lamp layers, e.g. by printing in several passes. In such case, for example, a dielectric ink can be used for the reinforcing strip. The reinforcing strip can be transparent, opaque, or colored. The invention is compatible with EL lamps having a reinforcing frame or skeleton, as disclosed in application Ser. No. 10/229,977, filed Aug. 28, 2002, now U.S. Pat. No. ______, in that the reinforcing strip is added to the skeleton. Although UV curable ink is used in a preferred embodiment, solvent based inks can be used instead. Further, a reinforcing strip made from a segment of tape can be used instead of screen printed ink. A unitary strip can be used or a segmented strip, e.g. one segment for each connector, can be used.

1. In a thick film, inorganic, EL panel having one or more luminous areas on a transparent, flexible substrate 1-5 mils thick and a feature on at least one side of the panel, the improvement comprising:
a reinforcing strip overlying at least a portion of said feature on a side of said panel opposite said one side.

2. The EL panel as set forth in claim 1 wherein said reinforcing strip includes a screen printed layer less than 1 mil thick.

3. The EL panel as set forth in claim 1 wherein said reinforcing strip is made from a sheet of material that is adhesively bonded to said EL panel.

4. The EL panel as set forth in claim 1 wherein said reinforcing strip includes a UV curable material.

5. The EL panel as set forth in claim 1 wherein said reinforcing strip is substantially opaque.

6. The EL panel as set forth in claim 1 wherein EL panel includes a rear electrode and said reinforcing strip overlies said rear electrode.

7. The EL panel as set forth in claim 1 wherein said EL panel includes a transparent front electrode and a rear electrode and wherein said reinforcing strip is located between said front electrode and said rear electrode.
